(19) United States
(12) Patent Application Publication
(10) Pub. No.: US 2025/0038514 A1
(43) Pub. Date: Jan. 30, 2025

(54) Short-Circuit Protection Having Wide Common Mode Voltage

(71) Applicant: TEXAS INSTRUMENTS INCORPORATED, Dallas, TX (US)

(72) Inventors: Prateek Pandey, Bangalore (IN); Koshal Sharma, Bangalore (IN); Aalok Dyuti Saha, Bangalore (IN)

(21) Appl. No.: 18/775,027

(22) Filed: Jul. 17, 2024

(30) Foreign Application Priority Data
Jul. 26, 2023 (IN) 202341050436

(51) Int. Cl. H02H 3/08

(52) U.S. Cl. CPC H02H 3/08

(57) ABSTRACT

An apparatus includes a first comparator having first and second inputs, a first control input, an output, and a supply voltage terminal. A second comparator has first and second inputs, a second control input, and an output. The second comparator's first input is coupled to the first input of the first comparator. The second comparator's second input is coupled to the first comparator's second input. A switchover logic circuit has an input, a first output, a second output, and a third output. The input of the switchover logic circuit is coupled to the first inputs of the first and second comparators. The first output of the switchover logic circuit is coupled to the supply voltage terminal of the first comparator. The second output of the switchover logic circuit is coupled to the first control input. The third output of the switchover logic circuit is coupled to the second control input.

### CROSS-REFERENCE TO RELATED APPLICATIONS

This application claims priority to India Provisional Application No. 20/234,1050436, filed Jul. 26, 2023, which is hereby incorporated by reference.

### BACKGROUND

Some applications of electronic circuits include short circuit protection (SCP) in which a SCP circuit detects an over-current condition and, in response, turns off a transistor to stop the flow of current. The SCP circuit should operate over the range of common mode voltages for the given application. Some applications have a substantially large common mode voltage range. The large common mode voltage range may result from the application starting the flow of current to a load and the load voltage rises from 0V towards its steady state level, which may be, for example, 70V. A large common mode voltage range substantially complicates the design of the SCP circuit.

### SUMMARY

In an example, an apparatus includes a first comparator having first and second inputs, a first control input, an output, and a supply voltage terminal. A second comparator has first and second inputs, a second control input, and an output. The second comparator's first input is coupled to the first input of the first comparator. The second comparator's second input is coupled to the first comparator's second input. A switchover logic circuit has an input, a first output, a second output, and a third output. The input of the switchover logic circuit is coupled to the first inputs of the first and second comparators. The first output of the switchover logic circuit is coupled to the supply voltage terminal of the first comparator. The second output of the switchover logic circuit is coupled to the first control input. The third output of the switchover logic circuit is coupled to the second control input.

### BRIEF DESCRIPTION OF THE DRAWINGS

FIG. 1 is a system diagram including a control circuit with first and second comparators and a switchover logic circuit, in an example.

FIG. 2 is a system diagram illustrating additional detail of the switchover logic circuit of FIG. 1, in an example.

FIG. 3 are waveforms illustrating the operation of the control circuit, in an example.

FIG. 4 is a circuit schematic of the first comparator of FIG. 1, in an example.

FIG. 5 is a circuit schematic of the second comparator of FIG. 1, in an example.

FIG. 6 is a circuit schematic of the second comparator of FIG. 1 with additional illustrative detail, in an example.

FIG. 7 is a system diagram including the control circuit of FIG. 1, in another example.

### DETAILED DESCRIPTION

The same reference numbers or other reference designators are used in the drawings to designate the same or similar (either by function and/or structure) features.

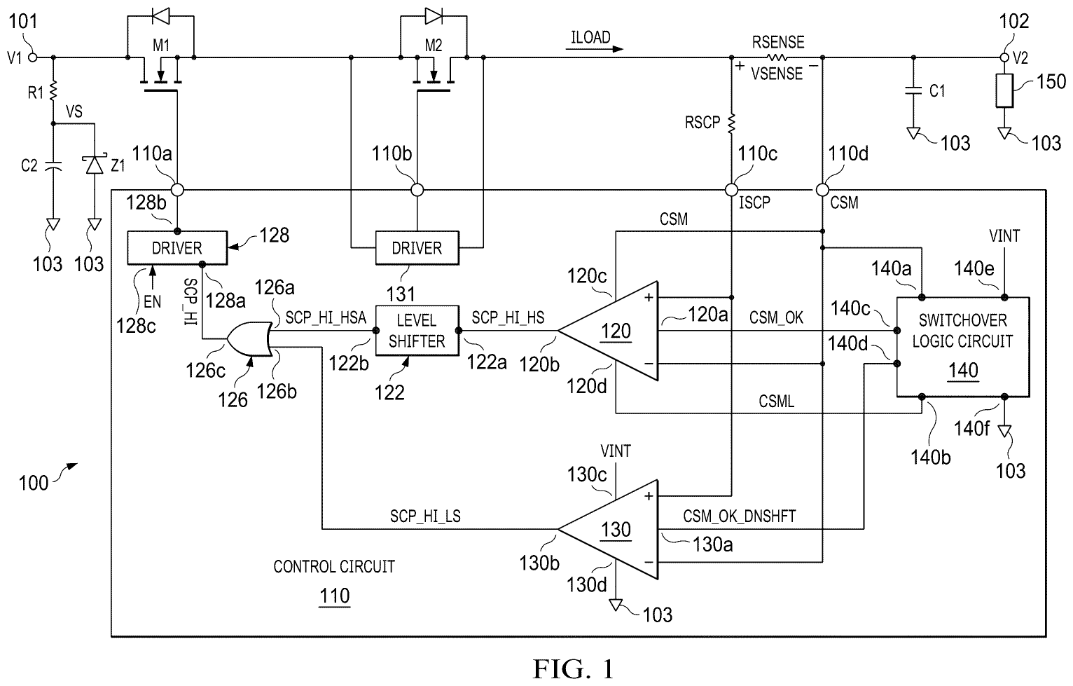

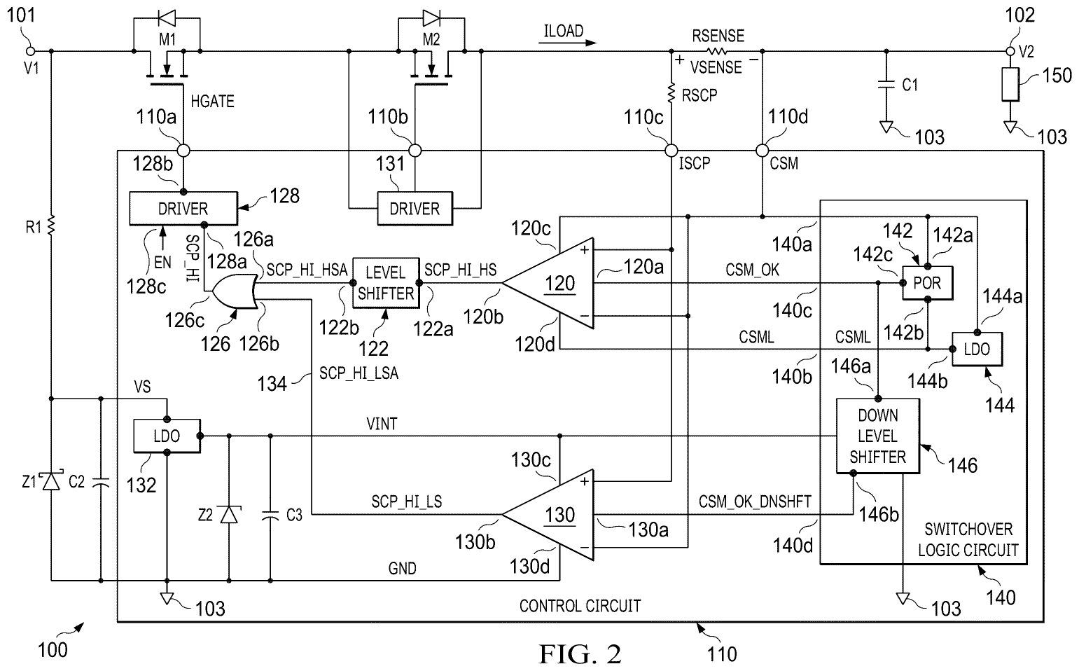

FIG. 1 is a diagram of a system 100 in an example including a first transistor M1, a second transistor M2, a sense resistor RSENSE, and a control circuit 110. In the example of FIG. 1, system 100 also includes a Zener diode Z1, capacitors C1 and C2, resistors R1 and RSCP (resistor short-circuit protection), and a load 150. In one example, system 100 may be included within a vehicle (e.g., an electric vehicle) and load 150 may include a subsystem within the vehicle such as an infotainment center, advanced driver assistance system (ADAS), lighting, etc. Transistors M1 and M2 are field effect transistors (FETs). For example, transistors M1 and M2 are n-channel FETs (NFETs). Transistors M1 and M2 and sense resistor RSENSE are coupled in series between an input terminal 101 and an output terminal 102. The sources of transistors M1 and M2 are coupled together. Control circuit 110 includes terminals 110a, 110b, 110c, and 110d. Terminal 110a is coupled to the gate of transistor M1. Terminal 110b is coupled to the gate of transistor M2. One terminal of resistor RSCP is coupled to terminal 110c and the other terminal of resistor RSCP is coupled to the drain of transistor M2 and to the sense resistor RSENSE. The other terminal of the sense resistor RSENSE is coupled to terminal 110d, to a plate of capacitor C1, and to load 150. The other plate of capacitor C is coupled to a ground terminal 103. Resistor R1 and capacitor C2 are coupled in series between terminal 101 and ground terminal 103. Zener diode Z1 is coupled across capacitor C2. The voltage across capacitor C2 and Zener diode Z1 is voltage VS and is used within control circuit 110, as shown in FIG. 2 and described below.

Control circuit 110 includes comparators 120 and 130, a level shifter 122, an OR gate 126 (which may be one or more logic gates in addition to or other than an OR gate in other examples), drivers 128 and 131, and a switchover logic circuit 140. Switchover logic circuit 140 includes an input 140a and outputs 140b, 140c, and 140d, and supply voltage terminals 140c and 140f. Supply voltage terminal 140f is coupled to the ground terminal 103. Comparator 120 has a positive (+) input, a negative (−) input, a control input 120a, an output 120b, and supply voltage terminals 120c and 120d. Comparator 130 has a positive input, a negative input, a control input 130a, an output 130b, and supply voltage terminals 130c and 130d. Level shifter 122 has an input 122a and an output 122b. OR gate 126 has inputs 126a and 126b and an output 126c. Driver 128 has an inputs 128a and 128c and an output 128b. Input 128c receives and enable signal EN that causes driver 128 to turn transistor M1 on and off. For example, driver 128 turns transistor M1 on responsive to enable signal EN being logic high and off responsive to enable signal EN being logic low. Driver 131 causes transistor M2 to turn on and off based on the source-to-drain voltage (VSD) of transistor M2. For example, when the VSD of transistor M2 is above a threshold (e.g., 200 mV), driver 131 causes transistor M2 to turn on. When the VSD of transistor is below the threshold, driver 131 causes transistor M2 to turn off.

Terminal 110d of control circuit 110 is coupled to the input 140a of switchover logic circuit 140 and to the supply voltage terminal 120c of comparator 120. Output 140c of control circuit 140 is coupled to control input 120a of comparator 120. Control circuit 140 generates a signal CSM_OK at its output 140c. Output 140d of switchover logic circuit 140 is coupled to the control input 130a of comparator 130. Switchover logic circuit 140 generates a signal CSM_OK_DNSHFT at its output 140d. Output 140b of switchover logic circuit 140 is coupled to supply voltage terminal 120d of comparator 120. Terminal 110c, which has a voltage ISCP, of control circuit 110 is coupled to the positive inputs of comparators 120 and 130. Terminal 110d, which has a voltage CSM, of control circuit 110 is coupled to the negative inputs of comparators 120 and 130. Supply voltage terminal 130c of comparator 130 and supply voltage terminal 140e of switchover logic circuit 140 receives a voltage VINT which, as described below, is generated based on voltage VS. The output 120b of comparator 120 is coupled to input 122a of level shifter 122. The output 122b of level shifter 122 and the output 130b of comparator 130 are coupled to inputs 126a and 126b, respectively, of OR gate 126. The output 126c of OR gate 126 is coupled to the input 128a of driver 128, and the output 128b of drier 128 is coupled through terminal 110 of control circuit 110 to the gate of transistor M1.

In one example, control circuit 110 may be fabricated as an integrated circuit (IC) and transistors M1 and M2, resistors R1, RSCP, and RSENSE, capacitors C1 and C2, Zener diode Z1, and load 150 are external to the IC containing control circuit 110. In other examples, any one or more of transistors M1 and M2, resistors R1, RSCP, and RSENSE, capacitors C1 and C2, and Zener diode Z1 may be fabricated on the same IC as control circuit 110.

A voltage V1 may be provided to the input terminal 101. Control circuit 110 turns on transistors M1 and M2 allowing current ILOAD to flow from input terminal 101 through transistors M1 and M2 and sense resistor RSENSE to the output terminal 102 and load 150 to thereby provide power (voltage V2) to load 150. Current ILOAD flowing through sense resistor RSENSE generates a voltage VSENSE across sense resistor RSENSE. Control circuit 110 determines whether the voltage VSENSE exceeds a threshold indicative of a possible short circuit condition. In response to voltage VSENSE exceeding the threshold, control circuit causes transistor M1 to turn off.

In one example, comparators 120 and 130 are configured to determine whether the differential voltage between their positive and negative inputs (e.g., the difference between voltages ISCP and CSM) exceeds a threshold equal to approximately 20 mV. Resistor RSCP is used to scale the otherwise fixed SCP threshold of comparators 120 and 130. The voltage at terminals 110c and 111d, relative to ground, may have a wide common mode voltage range, e.g., 0V to 70V. The common mode voltage range for comparator 120 (e.g., 3V to 70V) may be higher than the common mode voltage range for comparator 130 (e.g., 0V to 5V). In some examples, more than two comparators may be included. For example, to support common mode voltages larger than 70V, a third comparator may be included. Accordingly, comparator 120 operates at a lower common mode voltage range than comparator 130, but an overlapping common mode voltage of, e.g., 3V to 5V. Based, at least in part, on the voltage CSM at terminal 110d, switchover logic circuit 140 determines which of comparators 120 or 130 are to be enabled and disabled. For example, at lower common mode voltages of voltage CSM (e.g., 0V to approximately 2.4V), switchover logic circuit 140 asserts signal CSM_OK to a logic level (e.g., logic low) to disable comparator 120 and asserts signal CSM_OK_DNSHFT to a logic level (e.g., logic low to enable comparator 130. At higher common mode voltages of voltage CSM (e.g., above 2V), switchover logic circuit 140 asserts signal CSM_OK to a logic level (e.g., logic high) to enable comparator 120 and asserts signal CSM_OK_DNSHFT to a logic level (e.g., logic high) to disable comparator 130. Because comparator 120 operates at higher common mode voltage range, the signal SCP_HI_HS at its output 120b is down shifted by level shifter 122 to be within the same voltage domain as comparator 130, whose output signal is SCP_HI_LS. The output signal from level shifter 122 is signal SCP_HI_HSA. Signals SCP_HI_HSA and SCP_HI_LS from comparators 130 and 120, respectively, are logically OR'd together by OR gate 126. If either comparator 120 or 130 generates its output signal SCP_HI_HS or SCP_HI_LS, respectively, to be logic high, then OR gate 126 generates its output signal SCP_HI to a logic high state. Driver 128 responds to a logic high assertion of its input signal SCP_HI by turning off transistor M1. Otherwise (when signal SCP_HI is logic low), driver 128 does not turn off transistor M1.

Capacitor C1 may be located closer to load 150 than transistors M1/M2 and control circuit 110. Capacitor C1 may be a large capacitor (e.g., a few micro-Farads to a few milli-Farads). When transistors M1 and M2 Turn on, current through transistors M1 and M2 flows to load 150 and charges capacitor C1. Capacitor C1 can provide current to load 150 during any intermittent power cessation from voltage V1. Resistor R1 and capacitor C1 form a low-pass filter to produce voltage VS. Zener diode Z1 clamps voltage VS, which is used as described below to generate voltage VINT for comparator 120 and switchover logic circuit 140.

FIG. 2 is a schematic diagram of system 100 which includes an example implementation of switchover logic circuit 140 and additional detail for how voltage VINT to comparator 130 and switchover logic circuit 140 is generated. In the example of FIG. 2, switchover logic circuit 140 includes a power-on reset (POR) circuit 142, a low voltage drop-out regulator (LDO) 144, and a down-level shifter 146. POR circuit 142 has terminals 142a and 142b and an output 142c. LDO 144 has an input 144a and an output 144b. Down-level shifter 146 has an input 146a and an output 146b. Input 140a of switchover logic circuit 140 is coupled to terminal 142a of POR circuit 142 and to input 144a of LDO 144. Terminal 142b of POR circuit 142 is coupled to output 140b of switchover logic circuit 140 and to output 144b of LDO 144. Output 142c of POR circuit 142 is coupled to output 140c of switchover logic circuit 140 and to input 146a of down-level shifter 146. The output 146b of down-level shifter 146 is coupled to output 140d of switchover logic circuit 140.

LDO 144 produces an output voltage CSML at its output 144b based on the voltage CSM at its input 144a. In one example, at steady state LDO 144 produces voltage CSML at a level that is approximately 4V less than the voltage CSM. When transistors M1 and M2 are initially turned on, voltage V2 ramps up from 0V towards the level of voltage V1 as capacitor C1 charges. Voltage CSM is equal to voltage V2. Accordingly, voltage CSM to POR circuit 142 ramps up from 0V when transistors M1 and M2 are turned on. When voltage CSM is less than the regulated voltage level of LDO, voltage CSML will be at 0V. When voltage CSM rises above 4V, LDO 144 begins to produce voltage CSML at a level that is 4V below CSM. Accordingly, as voltage CSM continues to rise towards voltage V1, voltage CSML also ramps up at the same rate as voltage CSM, while remaining 4V below voltage CSM

POR circuit 142 generates signal CSM_OK. Down-level shifter 146 shifts the voltage level of signal CSM_OK to a lower level compatible with the voltage domain of comparator 130. POR circuit 142 monitors the difference between voltages CSM and CSML. While the voltage difference between CSM and CSML is less than approximately 2.4V, POR circuit 142 asserts signal CSM_OK to a logic low state, which causes comparator 130 to be enabled and comparator 120 to be disabled. When the voltage difference between voltages CSM and CSML reaches approximately 2.4V, POR circuit 142 asserts signal CSM_OK to a logic high state, which causes comparator 130 to be disabled and comparator 120 to be enabled.

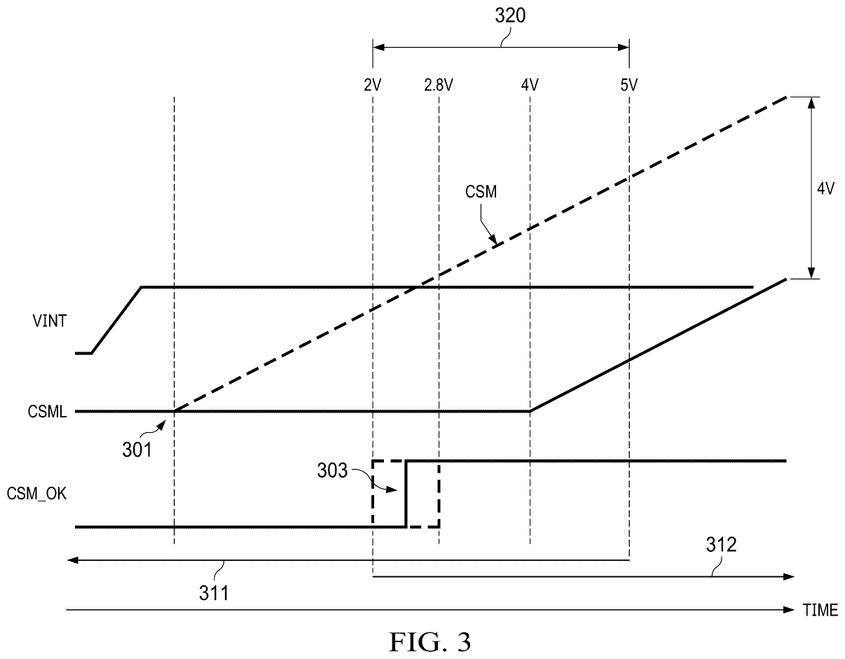

FIG. 3 are waveforms illustrating the operation of control circuit 110. FIG. 3 includes sample waveforms for voltages VINT, CSM, and CSML, and signal CSM_OK. At time point 301, transistors M1 and M2 turn on. When transistors M1 and M2 turn on, current flowing through the transistors begins to charge capacitor C1. Accordingly, voltage CSM begins to rise. When the difference between voltages CSM and CSML reaches approximately 2.4V, POR circuit 142 responds by asserting signal CSM_OK to a logic high state as shown at 303. In one example, due to component value variations within POR circuit 142, POR circuit 142 asserts signal CSM_OK to a logic high state when the difference between voltages CSM and CSML reaches, for example, 2.4V +/−0.4V, that is when the difference between voltages CSM and CSML is between 2V and 2.8V. At time point 305, voltage CSM has reached 4V and LDO 144 causes its output voltage CSML to begin to rise. LDO 144 maintains voltage CSML at a level that is approximately 4V below voltage CSM.

FIG. 3 also illustrates the common mode voltage operational overlap between comparators 120 and 130. Comparator 130 is a lower common mode voltage comparator and comparator 120 is a higher common mode voltage comparator. Line 311 indicates the common mode voltage range for comparator 130. Line 312 indicates the common mode voltage range for comparator 120. Reference numeral 320 identifies the overlap region in which either comparator 120 or 130 can be operational to determine whether the differential input voltage to the comparators is above the threshold, e.g., 20 mV. Having a common mode voltage operational overlap for the comparators advantageously helps to ensure seamless operational through the entire common mode voltage range for V2 of, e.g., 0V to 70V.

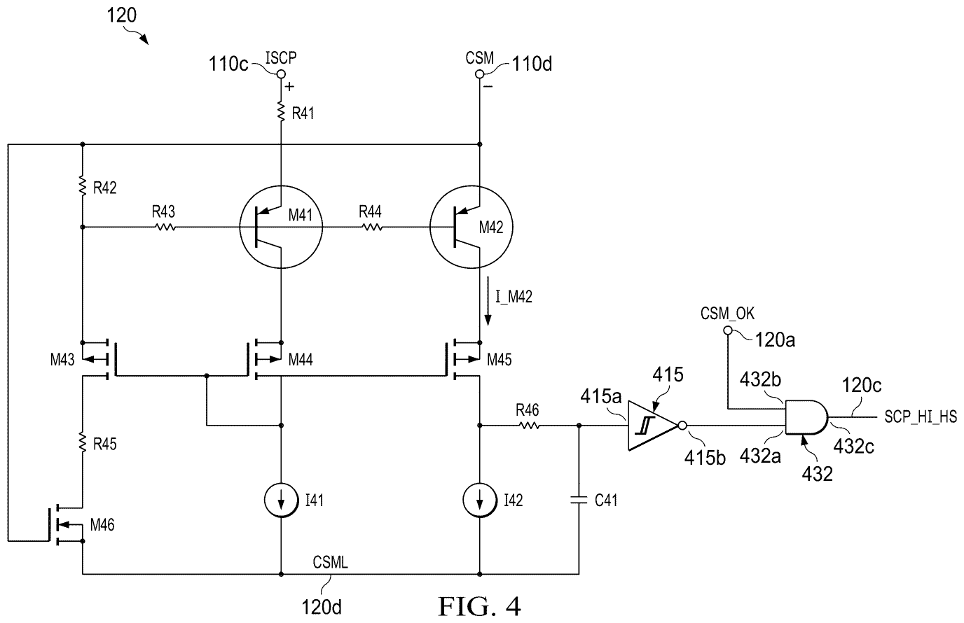

FIG. 4 is a circuit schematic for comparator 120 in an example. Comparator 120 may be referred to as a common gate comparator. Comparator 120 includes transistors M41, M42, M43, M44, and M45, resistors R41, R42, R43, R44, R45, and R46, current source circuits I41 and I42, an inverting Schmitt trigger 415, and an AND gate 432. In this example, transistors M41 and M42 are bipolar junction transistors, e.g., PNP bipolar junction transistors, transistors M43-M45 are PFETS, and transistor M46 is an NFET.

Resistor R41 is coupled between the positive input (which is coupled to terminal 110c of control circuit 110) and the emitter of transistor M41. Terminal 110d and the negative input of comparator 120 is coupled to the emitter of transistor M42. One terminal of resistor R44 is coupled to the base of transistor M41 and the other terminal of resistor R44 is coupled to the base of transistor M44. One terminal of resistor R42 is coupled to the emitter of transistor M42, and the other terminal of resistor R42 is coupled to the source of transistor M43. One terminal of resistor R43 is coupled to the base of transistor M41, and the other terminal of resistor R43 is coupled to the source of transistor R43.

The gates of transistors M43, M44, and M45 are coupled together and to the drain of transistor M44. The source of transistor M44 is coupled to the collector of transistor M41. The source of transistor M45 is coupled to the collector of transistor M42. One terminal of resistor M45 is coupled to the drain of transistor M43, and the other terminal of resistor R45 is coupled to the drain of transistor M46. The base of transistor M46 is couple to terminal 110d. The source of transistor M46 is coupled to the supply voltage terminal 120d. One terminal of current source circuit I41 (I41 refers both to the circuit that generates the current and the current produced therefrom) is coupled to the drain of transistor M44, and the other terminal of current source circuit I41 is coupled to supply voltage terminal 120d. Similarly, one terminal of current source circuit I42 (I42 refers both to the circuit that generates the current and the current produced therefrom) is coupled to the drain of transistor M45, and the other terminal of current source circuit I42 is coupled to supply voltage terminal 120d.

Inverting Schmitt trigger 415 has an input 415a and an output 415b. Resistor R46 is coupled between the drain of transistor R45 and the input 415a of inverting Schmitt trigger 415. Schmitt trigger 415 inverts the logic state of its input signal. AND gate 432 has inputs 432a and 432b and an output 432c. Output 415b of inverting Schmitt trigger 415 is coupled to input 432a of AND gate 432. Control input 120a of comparator 120 is coupled to input 432b of AND gate 432. Output 432c of AND gate 432 is coupled to output 120b of comparator 120.

In one example, the magnitude of currents I41 and I42 are approximately equal. The resistance of resistor R41 and the magnitude of current I41 sets the 20 mV threshold for the comparator. In one example, the resistance of resistor R41 is 2 kohms and current I41 and I42 are 10 micro-amperes (μA). In operation, if voltage ISCP at the positive input is more than 20 mV higher than voltage CSM at the negative input, then the emitter voltage of transistor M41 will be higher than the emitter voltage transistor M42. The base voltages of transistors M41 and M42 are approximately equal and based on the emitter voltage of transistor M41. Accordingly, with the emitter voltage of transistor M41 being higher than the emitter voltage of transistor M42, the emitter-to-base voltage (Veb) of transistor M42 will be lower than the Veb of transistor M41. In this case, the current through transistor M42, I_M42, will be lower than current I42 resulting in the drain voltage of transistor M45 decreasing. Resistor R46 and capacitor C41 form a low-pass filter to filter the voltage at the drain of transistor M45 for input into the inverting Schmitt trigger 415. Inverting Schmitt trigger's output signal will be logic high as the drain voltage transistor M45 decreases. If signal CSM_OK is logic high (comparator 120 enabled), then the output signal SCP_HI_HS from AND gate 432 will be at the same logic state as the output signal from inverting Schmitt trigger 415. Accordingly, if voltage ISCP at the positive input is more than 20 mV higher than voltage CSM at the negative input, then the output signal from inverting Schmitt trigger 415 and will be logic high and AND gate 432 will force signal SCP_HI_HS to a logic high state as well.

If voltage ISCP at the positive input is smaller than 20 mV above the voltage CSM at the negative input, then the emitter voltage of transistor M41 will be smaller than the emitter voltage transistor M42. With the emitter voltage of transistor M41 being lower than the emitter voltage of transistor M42, the Veb of transistor M42 will be higher than the Veb of transistor M41. In this case, the current I_42 through transistor M42 will be higher than current I42 resulting in the drain voltage of transistor M45 increasing. Inverting Schmitt trigger's output signal will be logic low as the drain voltage transistor M45 increases. With signal CSM_OK at a logic high state, then the output signal SCP_HI_HS from AND gate 432 will be logic low. Accordingly, if voltage ISCP at the positive input is smaller than 20 mV above the voltage CSM at the negative input, then the output signal from inverting Schmitt trigger 415 and will be logic low and AND gate 432 will force signal SCP_HI_HS to a logic low state as well.

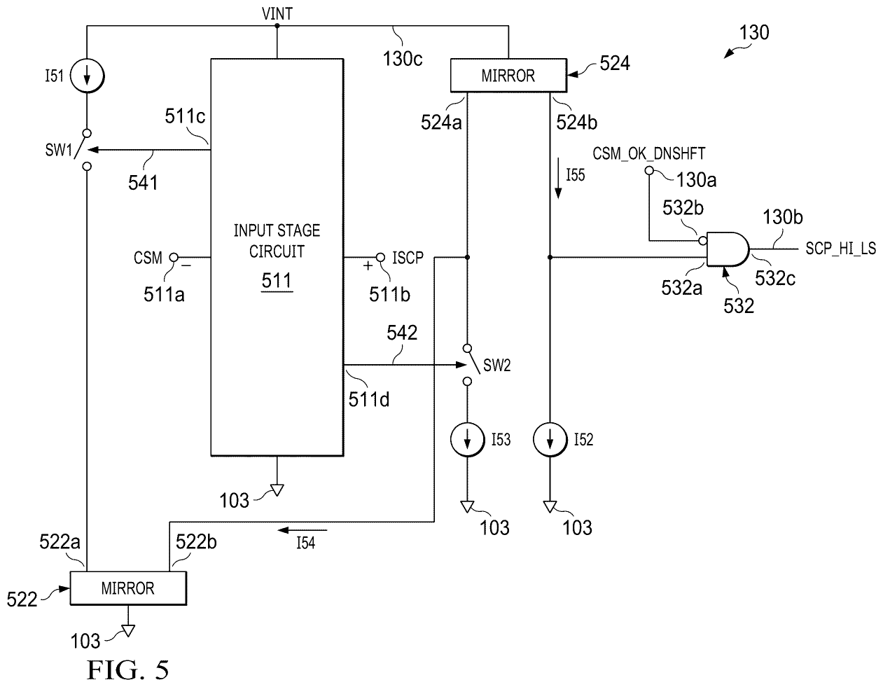

FIG. 5 is a block diagram of comparator 130, which includes an input stage circuit 511, current mirrors 522 and 524, switches SW1 and SW2, current source circuits I51, I52, and I53 (I51, I52, and I53 refer to the circuits that produce the currents as well as the currents themselves), and AND gate 532. Input stage circuit 511 has inputs 511a (the comparator's negative input) and 511b (the comparator's positive input) and outputs 511c and 511d. Output 511c is coupled to a control input of switch SW1. Output 511d is coupled to a control input of switch SW2. Current source circuit I51 is coupled between supply voltage terminal 130c and one terminal of switch SW1. The other terminal of switch SW1 is coupled to an input 522a of current mirror 522. The output 522b of current mirror 522 is coupled to the input 524a of current mirror 524. Switch SW2 is coupled in series with current source circuit I53 between the input 524a of current mirror 524 and ground terminal 103. Current source circuit I52 is coupled between the output 524b and gr and ground terminal 103.

AND gate 532 has inputs 532a and 532b and an output 532c. Input 532a is an inverted input. The output 524b of current mirror 524 is coupled to the input 532a of AND gate 532. The control input 130a of comparator 130 is coupled to the input 532b of AND gate 532. The output 532c of AND gate 532 is coupled to the output 130b of comparator 130. AND gate logically ANDs the inverse of signal CSM_OK_DNSHFT with the voltage at the output 524b of current mirror 524 to produce signal SCP_HI_LS. In one example, comparator 130 is enabled when signal CSM_OK_DNSHFT is logic low, and comparator 130 is disables when signal CSM_OK_DNSHFT is logic high.

Comparator 130 is operable over a common mode voltage range from 0V to 5V, for example. Input stage circuit 511 is configured such that at a lower common mode range, e.g., 0V to 1.5V, within the 0V to 5V range, input stage circuit 511 asserts signal 541 to cause switch SW1 to close in response to voltage ISCP being more than, for example, 20 mV greater than voltage CSM. With switch SW1 closed, current I51 flows into input 522a of current mirror 522. Current mirror 522 mirrors current I51 as current I54. Current mirror 524 mirrors current I54 as current I55. In one example, current I51 is 0.5 μA, current I52 is 2.5 μA, current I53 is 0.5 μA, the mirror ratio of current mirror 522 is 1:1, and the mirror ratio of current mirror 524 is 1:10. Accordingly, when switch SW1 closes, current I54 is 0.5 μA and current I55 is 5 μA. With current I55 being larger than current I52, the voltage across current source I52 increases thereby causing AND gate 532 to force signal SCP_HI_LS to a logic high state, when signal CSM_OK_DNSHFT is logic low.

Input stage circuit 511 is configured such that at a higher common mode range, e.g., 1V to 5V, within the 0V to 5V range, input stage circuit 511 asserts signal 542 to cause switch SW2 to close in response to voltage ISCP being more than, for example, 20 mV greater than voltage CSM. With switch SW2 closed, current I53 is mirrored by current mirror 524 as current I55. In the example in which current I53 is 0.5 μA, current mirror 524 causes current I55 to be 5 μA and, as described above, with current I55 (5 μA) being greater than current I52 (2.5 μA), input 532a of AND gate becomes logic high thereby causing AND gate to force signal SCP_HI_LS to a logic high state when signal CSM_OK_DNSHFT is logic low.

As described above, input stage circuit 511 has two overlapping common mode voltage ranges, 0-1.5V and 1V-5V. Within the overlapping region of 1V to 1.5V, input stage circuit 511 asserts both signals 541 and 542 to logic states to cause switches SW1 and SW2 to both be closed when voltage ISCP is more than 20 mV larger than voltage CSM. With both switches SW1 and SW2 closed, the input current of current mirror 524 is the sum of currents I53 and I54, which causes current I55 to be larger than current I52. AND gate forces. SCP_HI_LS to a logic high state indicating the ISCP is more than 20 mV larger than voltage CSM.

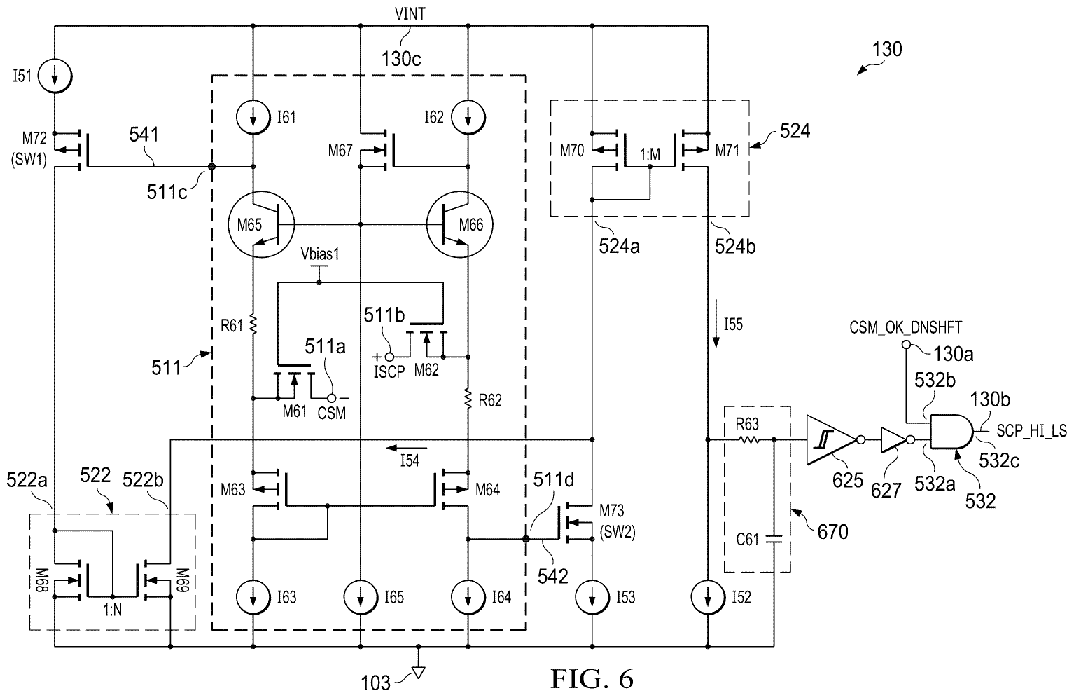

FIG. 6 is a schematic diagram illustrating an example implementation of current mirrors 522 and 524 and input stage circuit 511. Current mirror 522 includes NFET transistors M68 and M69 coupled together to form the current mirror with a mirror ratio of 1:N. In one example, N is 1 but can be other than 1 in other examples. Current mirror 524 includes PFET transistors M70 and M71 coupled together to form the current mirror with a mirror ratio of 1:M. In one example, M is 10 but can be other than 10 in other examples. Switches SW1 and SW2 are transistors M72 and M73, respectively. Transistor M72 is a PFET and transistor M73 is an NFET in the example of FIG. 6.

Input stage circuit 511 includes transistors M61, M62, M63, M64, M65, M66, and M67, resistors R61 and R62, and current source circuits I61, I62, I63, I64, and I65. In this example, transistors M65 and M66 are NPN BJTs. In this example, transistors M61, M62, and M67 are NFETs and transistors M63 and M64 are PFETs. The drain of transistor M67 is coupled to supply voltage terminal 130c, and the source of transistor M67 is coupled to the bases of transistors M65 and M66. Current source circuit I65 is coupled between the source of transistor M67 and the ground terminal 103. Transistor M67 is a natural transistor and provides base compensation for transistors M65 and M66. Inputs 511a and 511b are coupled to the drains of transistors M61 and M62, respectively. The gates of transistors M61 and M62 are coupled together and receive a bias voltage Vbias1 (e.g., a voltage greater than 5V). Current source circuits I61 and I62 are coupled between the supply voltage terminal 130c and the collectors of transistors M65 and M66, respectively.

Resistor R61 is coupled between the emitter of transistor M65 and the sources of transistors M61 and M63. The emitter of transistor M66 is coupled to the source of transistor M62 and to a terminal of resistor R62. The other terminal of resistor R62 is coupled to the source of transistor M64. The gates of transistors M63 and M64 are coupled together and to the drain of transistor M63. Current source circuit I63 is coupled between the drain of transistor M63 and ground terminal 103. Similarly, current source circuit I64 is coupled between the drain of transistor M64 and ground terminal 103. In one example, currents I61, I62, I63, and I64 are of equal magnitude and the resistances of resistors R61 and R62 are equal. The voltage across resistors R61 and R62 is the threshold voltage for comparator 130. In one example, the threshold voltage is 20 mV, which may be obtained by setting currents I61, I62, I63, and I64 at 1 μA and the resistance of resistors R61 and R62 at 20kΩ.

The gate of transistor M72 (switch SW1) is coupled to the collector of transistor M65. Current source circuit 151 is coupled between supply voltage terminal 130c and the source of transistor M72. The drains of transistors M72 and M68 are coupled together. The sources of transistors M68 and M69 are coupled together and to ground terminal 103. The drain of transistor M69 is coupled to the drains of transistors M70 and M73. Current source circuit I53 is coupled between the source of transistor M73 (switch SW2) and ground terminal 103. Current source circuit I52 is coupled between the drain of transistor M71 and ground terminal 103.

Comparator 130 in the example of FIG. 6 also includes a low-pass filter (which may be omitted in other examples) including resistor R63 coupled to capacitor C61. Comparator 130 also includes an inverting Schmitt trigger 625 and an inverter 627 coupled in series between resistor R63 and input 532a of AND gate 532. Low-pass filter filters the voltage at the output 524b of current mirror 524 and provides a filtered voltage to an input of inverting Schmitt trigger 625. Inverting Schmitt trigger produces an inverted output signal which is again inverted by inverter 627.

Transistors M65 and M66 from a first input transistor pair that is operational at an input common mode voltage less than VINT−Von1−Vbe, where Von1 is the voltage across current source circuits I61 and I62 and Vbe is the base-to-emitter voltage of transistors M65 and M66. In one example, the first input transistor pair comprising transistors M65 and M66 is operational for an input common mode voltage in the range of 0V to 1.5V. Transistors M63 and M64 form a second input transistor pair that is operational at an input common mode voltage greater than |Vtp|+Von2,where |Vtp| is the absolute value of the threshold voltage of transistors M63 and M64 and Von2 is the voltage across current source circuits I63 and I64. In one example, the second input transistor pair comprising transistors M63 and M64 is operational for an input common mode voltage in the range of 1V to 5V.

Within the lower common mode voltage range of 0-1.5V, transistors M63 and M64 operate in the linear region and transistors M65 and M66 operate in the forward active region. Within this lower common mode voltage range, if voltage ISCP is more than 20 mV greater than voltage CSM, then the small signal voltage at the bases of transistors M65 and M66 rises by an amount equal to the ISCIP−CSM−20 mV. The small signal voltage increase at the bases of transistors M65 and M66 causes an increase in current through resistor R61 which results in a decrease in the gate voltage of transistor M72. The drop in the gate voltage of transistor M72 causes transistor M72 to turn on thereby causing current I51 to flow into the input 522a of current mirror 522. As described above, current mirror 522 mirrors its input current as current I54, which is then mirrored by current mirror 524. The voltage at the input of inverting Schmitt trigger 625 then rises resulting in AND gate forcing signal SCP_HI_LS to a logic high state (assuming signal CSM_OK_DNSHFT is logic low to enable comparator 130).

Within the higher common mode voltage range of 1-5 V, if voltage ISCP is more than 20 mV greater than voltage CSM, then the source-to-gate voltage of transistor M64 rises because the gate voltage is fixed and determined by diode-connected transistor M63. Because voltage ISCP is rising, the same increase is present on the source of transistor M64. Accordingly, the source-to-gate voltage of transistor M64 becomes higher than that of transistor M63 by ISCIP−CSM−20 mV. This small signal voltage increase in the source-to-gate voltage of transistor M64 causes the gate voltage of transistor M73 to rise thereby turning on transistor M73. Consequently, and as described above, current mirror 524 mirrors the current through transistor M73 which results in a voltage increase at the input of inverting Schmitt trigger 625. AND gate 532 forces signal SCP_HI_LS to a logic high state.

Within the overlapping common mode voltage range of, for example, 1-1.5V, both transistors M72 and M73 are turned on if ISCP is more than 20 mV greater than voltage CSM. Current mirror 524 mirrors the sum of current I54 and I53, which results in a logic high at input 532a of AND gate 532. Accordingly, AND gate 532 forces signal SCP_HI_LS to a logic high state.

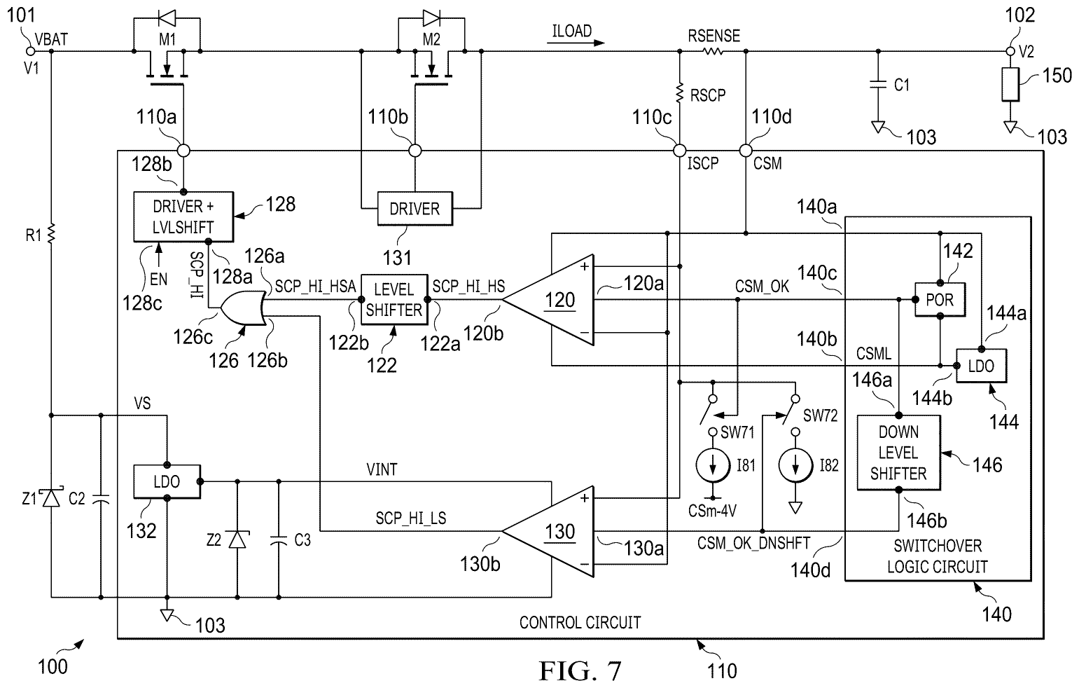

FIG. 7 is a schematic diagram of system 100 similar to that of FIG. 2 but includes switches SW71 and SW72 and current source circuits I81 and I82 to provide threshold scaling for comparators 120 and 130. The control input of switch SW71 receives signal CSM_OK and the control input of switch SW72 receives signal CSM_OK_DNSHFT. Switch SW71 is coupled between resistor RSCP and current source circuit 181. Similarly, SW72 is coupled between resistor RSCP and current source circuit 182. If either or both switches SW71 and SW72 are closed by their respective control signals CSM_OK and CSM_OK_DNSHFT, additional current from the corresponding current source circuits I81 and I82 flow through resistor RSCP thereby increasing the threshold voltage of the comparators (e.g., 20 mV) by a voltage that is the product of current sources I81/I82 and the resistance of resistor RSCP. In one example, the scaling is applicable for common mode voltages greater than the drain-to-source voltage when a transistor is on (e.g., 500 mV in one example).

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

What is claimed is:

1. An apparatus, comprising:
a first comparator having first and second inputs, a first control input, an output, and a supply voltage terminal;
a second comparator having first and second inputs, a second control input, and an output, the first input of the second comparator coupled to the first input of the first comparator, the second input of the second comparator coupled to the second input of the first comparator; and
a switchover logic circuit having an input, a first output, a second output, and a third output, the input of the switchover logic circuit coupled to the first inputs of the first and second comparators, the first output coupled to the supply voltage terminal of the first comparator, the second output coupled to the first control input, and the third output coupled to second control input.

2. The apparatus of claim 1, wherein the switchover logic circuit includes:
a voltage regulator having an input coupled to the first input of the switchover logic circuit and having an output coupled to the first output of the switchover logic circuit; and
a power-on reset (POR) circuit having a first terminal coupled to the first input of the switchover logic circuit, a second terminal coupled to the output of the voltage regulator, and an output coupled to the second output of the switchover logic circuit.

3. The apparatus of claim 2, wherein the switchover logic circuit further includes a level shifter having an input coupled to the output of the POR circuit and having an output coupled to the third output of the switchover logic circuit.

4. The apparatus of claim 1, wherein the second comparator includes:
a first current source circuit;
a first current mirror having a first mirror input and a first mirror output;
a first switch coupled between the first current source circuit and the first mirror input, the first switch having a first switch control input;
an input stage circuit having a first input coupled to the first input of the second comparator, a second input coupled to the second input of the second comparator, and a first output coupled to the first switch control input;
a second current mirror having a second mirror input and a second mirror output, the second mirror input coupled to the first mirror output; and
a second current source circuit coupled to the second mirror output.

5. The apparatus of claim 4, wherein the second comparator further includes:
a third current source circuit; and
a second switch coupled between the second mirror input and the third current source circuit, the second switch having a second switch control input; and
the input stage circuit also a second output coupled to the second switch control input.

6. The apparatus of claim 4, further comprising a logic gate having a first input coupled to the second mirror output, a second input coupled to the second control input of the second comparator, and an output coupled to the output of the second comparator.

7. The apparatus of claim 1, wherein the switchover logic circuit is configured to:
enable the output of the first comparator when a voltage at the first input is more than a threshold level above a voltage at the first output; and
enable the output of the second comparator when a voltage at the first input is less than the threshold level above the voltage at the first output;
wherein the threshold level is within a range for which both the first and second comparators are configured to be operational.

8. The apparatus of claim 1, further comprising:
a driver having an input and an output;
a logic gate having first and second inputs and an output, the output of the logic gate coupled to the input of the driver, the first input of the logic gate coupled to the output of the first comparator, and the second input of the logic gate coupled to the output of the second comparator;
a transistor having first and second terminals and a control input, the control input coupled to the output of the driver; and
a resistor having first and second resistor terminals, the first resistor terminal coupled to the second terminal of the transistor and to the second inputs of the first and second comparators, and the second resistor terminal coupled to the first inputs of the first and second comparators.

9. The apparatus of claim 8, wherein the logic gate is an OR gate.

10. An apparatus, comprising:
a first current source circuit;
a first current mirror having a first mirror input and a first mirror output;
a first switch coupled between the first current source circuit and the first mirror input, the first switch having a first switch control input;
an input stage circuit having a first input, a second input, and a first output coupled to the first switch control input;
a second current mirror having a second mirror input and a second mirror output, the second mirror input coupled to the first mirror output; and
a second current source circuit coupled to the second mirror output.

11. The apparatus of claim 10, wherein the apparatus further includes:
a third current source circuit; and
a second switch coupled between the second mirror input and the third current source circuit, the second switch having a second switch control input; and
the input stage circuit also a second output coupled to the second switch control input.

12. The apparatus of claim 10, wherein the apparatus has a control input, and the apparatus further comprises a logic gate having a first input coupled to the second mirror output, a second input coupled to the control input, and an output.

13. The apparatus of claim 12, wherein the logic gate is an AND gate.

14. The apparatus of claim 10, wherein the input stage circuit includes:
a first transistor having first and second terminals;
a second transistor having first and second terminals;
a third transistor having first and second terminals and a control input, the first terminal of the third transistor coupled to the second terminal of the first transistor;
a fourth transistor having first and second terminals and having a control input coupled to the control input and second terminal of the third transistor;
a fifth transistor having first and second terminals and a control input;
a first resistor coupled between the second terminal of the fifth transistor and the first terminal of the third transistor;
a sixth transistor having first and second terminals and having a control input coupled to the control input of the fifth transistor;
a second resistor coupled between the second terminal of the sixth transistor and the first terminal of the fourth transistor; and
a third current source circuit coupled to the first terminal of the fifth transistor and to the first output of the input stage circuit.

15. The apparatus of claim 14, wherein:
the apparatus further includes a third current source circuit and a second switch coupled between the second mirror input and the third current source circuit, the second switch having a second switch control input; and
the input stage circuit further includes a fourth current source circuit coupled to the second terminal of the fourth transistor and to the second switch control input.

16. The apparatus of claim 14, wherein the third and fourth transistors are field effect transistors, and the fifth and sixth transistors are bipolar junction transistors.

17. An apparatus, comprising:
a first current source circuit;
a first current mirror having a first mirror input and a first mirror output;
a first switch coupled between the first current source circuit and the first mirror input, the first switch having a first switch control input;
a second current mirror having a second mirror input and a second mirror output, the second mirror input coupled to the first mirror output;
a second current source circuit coupled to the second mirror output;
a third current source circuit;
a second switch coupled between the second mirror input and the third current source circuit, the second switch having a second switch control input; and
an input stage circuit having a first input, a second input, a first output, and a second output, the first output coupled to the first switch control input, and the second output coupled to the second switch control input.

18. The apparatus of claim 17, wherein the apparatus has a control input, and the apparatus further comprises an AND gate having a first input coupled to the second mirror output, a second input coupled to the control input, and an output.

19. The apparatus of claim 18, further comprising a low-pass filter having an input coupled to the second mirror output and having an output coupled to the first input of the AND gate.

20. The apparatus of claim 17, wherein the apparatus is configured to:
generate an output signal at a first voltage level at the second mirror output when a first signal at the first input of the input stage circuit is more than a threshold voltage larger than a second signal at the second input of the input stage circuit; and
generate the output signal at a second voltage level when the first signal is not more than the threshold voltage larger than the second signal.
